(19) United States
(12) Patent Application Publication
(10) Pub. No.: US 2014/0016299 A1
(43) Pub. Date: Jan. 16, 2014

(54) PHOTON ENHANCEMENT GUIDING STRUCTURES, DEVICES, AND METHODS FOR LIGHT EMITTING DEVICES

(71) Applicant: SL MATERIALS CO., LTD., Seongnam-si (KR)

(72) Inventors: Nguyen The TRAN, Garden Grove, CA (US); Jiung Ping YOU, Costa Mesai, CA (US)

(73) Assignee: SOLAR SCIENCE, CO., LTD., Seongnam-si (KR)

(21) Appl. No.: 13/730,460

(22) Filed: Dec. 28, 2012

Related U.S. Application Data
(60) Provisional application No. 61/659,443, filed on Jun. 14, 2012.

(51) Int. Cl. F21K 99/00

(52) U.S. Cl. CPC F21K 9/52
USPC 362/84

(57) ABSTRACT

The disclosure herein provides photon enhancement guiding structures, devices, and methods for light emitting devices. The structures, devices, and methods described herein can improve the efficiency and/or light distribution of light emitting devices.

### BACKGROUND

1. Field

This disclosure relates generally to the field of light emitting devices, and more specifically to photon enhancement guiding structures, deices, and methods for light emitting diodes.

2. Description

With the development of technologies in light emitting device, single and/or multiple light emitting chips or light sources, such as light emitting diode (LED) chips, can be used in light devices for light fixtures, backlighting for displays, or the like. Generally, in light emitting devices, some generated light can be trapped inside the device, resulting in low efficiency and lifetime. Further, the distribution of generated light to the exterior of the device can be inefficient and/or otherwise unsatisfactory, for example in terms of uneven color distribution. Accordingly, it can be advantageous to provide structures, devices, and methods to improve the efficiency and/or distribution of light emitting devices.

### SUMMARY

Advancements in light emitting device technologies make it possible to improve the efficiency and/or light distribution of light emitting devices via one or more guiding structures, deices, and methods.

One aspect of the invention provides a light emitting device, which comprises: an LED light source and a light guide structure placed over the LED light source. The LED light source comprises a light emitting diode (LED) and an encapsulation encapsulating the LED, the LED being configured to emit light beams of a first color, the encapsulation comprising at least one phosphor material configured to absorb light beams of the first color from the LED and emit light beams of a second color. The light guide structure placed over the LED encapsulation, the light guide structure comprising a body defined by a bottom, a top and a side, the light guide structure body being configured to receive via the bottom and direct to the top light beams from the LED encapsulation. The top comprises a total reflection surface configured to totally reflect at least part of incident light beams thereto within the light guide structure body and redirect the totally reflected light beams toward the side.

In the light emitting device, the total reflection surface may be configured to totally reflect substantially all incident light beams that are incident thereto within the light guide structure body at an angle smaller than about 75°, and the angle may be defined as one between a trajectory of the incident light beam to a point on the total reflection surface and a tangential line at the point on an imaginary plane including the trajectory of the incident light beam. The side may not comprise a total reflection surface such that substantially all light beams incident to the side within the light guide structure body are transmitted through the side to outside the light guide structure body. The total reflection surface may be slanted or curved with reference to an imaginary plane generally parallel to the bottom of the light guide structure. Between two points on the total reflection surface, one that may be closer to the side may be at a level higher than one that may be farther to the side, wherein the level may be measured with reference to the bottom. A tangential line at a point of the total reflection surface and the imaginary plane may form an acute angle ranging from about 20° to about 70°.

In the light emitting device, the top may further comprise another total reflection surface on a cross-section of the light guide structure body taken in a plane generally perpendicular to the bottom. The two total reflection surfaces on the cross-section may be configured to redirect light beams to generally opposite directions. The cross-section may be divided into two areas by an imaginary line perpendicular to the bottom, wherein one the two total reflection surfaces may be located in one side and the other of the two total reflection surfaces may be located in the other side. The two total reflection surfaces may meet at about the imaginary line on the cross-section. The two total reflection surfaces may be generally in a mirror image of each other along the imaginary line. The top may further comprises a non-total reflection surface between the two total reflection surfaces on the cross-section, wherein the non-total reflection surface may be configured to transmit substantially all incident light beams thereto within the light guide structure body rather than reflecting the incident light beams into the light guide structure body. The top may further comprises one or more additional total reflection surfaces between the two total reflection surfaces on the cross-section, wherein the one or more additional total reflection surfaces may be configured to totally reflect at least part of incident light beams thereto within the light guide structure body and redirect the totally reflected light beams to another portion of the top. The top may comprise at least one cone-shaped top portion between the two total reflection surfaces on the cross-section.

In the light emitting device, the total reflection surface and the side may form an edge, wherein the total reflection surface may be slanted or curved such that a point on the edge may be higher than another point of the total reflection surface. The total reflection surface may comprise a convex surface when viewing from outside the light guide structure body. The LED light source may comprise one or more additional LEDs forming an LED array.

Another aspect of the invention provides a method of directing light beams. The method comprises: providing the foregoing device; emitting light beams from the LED light source toward the light guide structure so that a light beam enters the light guide structure body and travels toward the total reflection surface of the top; and reflecting the light beam at the total reflection surface and directing the light beam to the side of the light guide structure such that the light beam passes the side to outside the light guide structure body. The method may further comprise: providing a reflective surface next to the side of the light guide structure; and reflecting at the reflective surface the light beam that has been redirected to the side and travels to outside the light guide structure body.

A further aspect of the invention provides a light emitting device: an LED light source configured to emit light beams of a first color; an LED encapsulation layer encapsulating the LED light source and further comprising at least one phosphor material configured to absorb light beams of the first color from the LED light source and emit light beams of a second color; a light guide structure placed over the LED encapsulation layer, the light guide structure comprising a body defined by a bottom, a top and a side, the light guide structure body being configured to receive via the bottom and direct to the top light beams from the LED encapsulation layer; and the top comprising a total reflection surface configured to totally reflect at least part of incident light beams thereto within the light guide structure body and redirect the totally reflected light beams toward the side.

In an embodiment, a light emitting device comprises: an LED light source comprising a light emitting diode (LED) and an encapsulation encapsulating the LED, the LED being configured to emit light beams of a first color, the encapsulation comprising at least one phosphor material configured to absorb light beams of the first color from the LED and emit light beams of a second color; a light guide structure placed over the LED encapsulation, the light guide structure comprising a body defined by a bottom, a top and a side, the light guide structure body being configured to receive via the bottom and direct to the top light beams from the LED encapsulation; and the top comprising a total reflection surface configured to totally reflect at least part of incident light beams thereto within the light guide structure body and redirect the totally reflected light beams toward the side.

In an embodiment, a method of directing light beams comprises: providing the above-described light emitting device; emitting light beams from the LED light source toward the light guide structure so that a light beam enters the light guide structure body and travels toward the total reflection surface of the top; and reflecting the light beam at the total reflection surface and directing the light beam to the side of the light guide structure such that the light beam passes the side to outside the light guide structure body.

In an embodiment, a light emitting device comprises: an LED light source configured to emit light beams of a first color; an LED encapsulation layer encapsulating the LED light source and further comprising at least one phosphor material configured to absorb light beams of the first color from the LED light source and emit light beams of a second color; a light guide structure placed over the LED encapsulation layer, the light guide structure comprising a body defined by a bottom, a top and a side, the light guide structure body being configured to receive via the bottom and direct to the top light beams from the LED encapsulation layer; and the top comprising a total reflection surface configured to totally reflect at least part of incident light beams thereto within the light guide structure body and redirect the totally reflected light beams toward the side.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF THE DRAWINGS

FIGS. 1A-1B illustrate examples of embodiments of light emitting devices comprising a hemispherical cover.

FIG. 2 illustrates light emitting patterns of examples of embodiments of light emitting devices.

FIG. 3 illustrates a cross-section view of an example of an embodiment of a light emitting device comprising an embodiment of a photon enhancement guiding structure.

FIG. 4 illustrates a perspective view of an example of an embodiment of a photon enhancement guiding structure.

FIGS. 5A-5B illustrate light travel patterns in examples of embodiments of photon enhancement guiding structures.

FIGS. 6A-6B illustrate light travel patterns in examples of embodiments of photon enhancement guiding structures with varying side surfaces.

FIGS. 7A-7B illustrate a perspective view and a cross-section view of an example of an embodiment of a photon enhancement guiding structure comprising a cone or pyramid structure.

FIGS. 8A-8B illustrate light travel patterns in examples of embodiments of photon enhancement guiding structures without a cone or pyramid structure.

FIG. 9 illustrates light travel patterns in an example of an embodiment of a photon enhancement guiding structure comprising a cone or pyramid structure.

FIG. 10 illustrates light emitting patterns in an example of an embodiment of an additional reflective surface used in conjunction with a photon enhancement guiding structure.

### DETAILED DESCRIPTION

Embodiments of the invention will now be described with reference to the accompanying figures. The terminology used in the description presented herein is not intended to be interpreted in any limited or restrictive manner, simply because it is being utilized in conjunction with a detailed description of certain specific embodiments of the invention. Furthermore, embodiments of the invention may comprise several novel features, no single one of which is solely responsible for its desirable attributes or which is essential to practicing the inventions herein described.

The disclosure herein provides photon enhancement guiding structures, devices, and methods for light emitting devices. The structures, devices, and methods described herein can improve the efficiency and/or light distribution of light emitting devices.

Light emitting devices can comprise one or more light sources. For example, light emitting devices can comprise one or more light emitting diode (LED) chips, fluorescent, incandescent, solar, or any other light generating source or chip that is currently available or to be developed in the future. Further, light emitting devices can comprise one or more phosphors or other materials that are configured to absorb and/or reemit light. Although some embodiments are described herein in relation to light emitting devices comprising an LED light source and/or LED chips, it should be understood to one of ordinary skill in the art that the underlying concepts disclosed herein can be applied to light emitting devices comprising any other type of light source.

Generally, for any type of light emitting device that comprises a light source, some generated light can be trapped inside the light emitting device, resulting in low efficiency and lifetime. Further, in certain light emitting devices, the distribution of generated light to the exterior of the light emitting device can be inefficient and/or otherwise unsatisfactory. For example, there can be uneven distribution of one or more colors or density of light in certain directions and/or areas. Accordingly, it can be advantageous to provide photon enhancement guiding structures, devices, and/or methods that can improve the efficiency and/or distribution of light emitted from a light emitting device.

### Hemispherical Cover

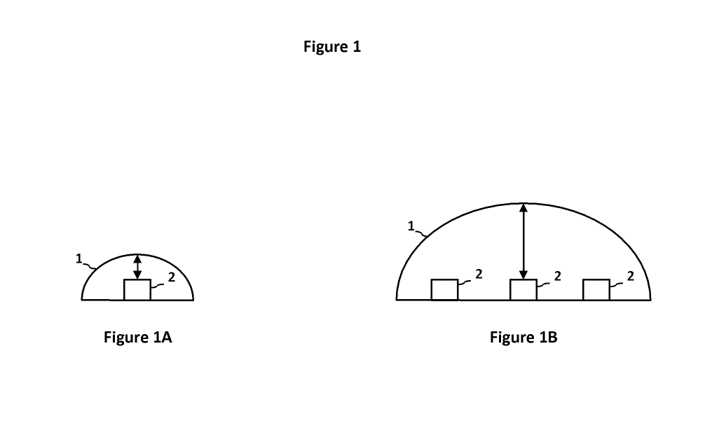

In some embodiments, a light emitting device can comprise a convex, hemispherical lens configured to control and/or improve the distribution of light and/or efficiency. FIG. 1A illustrates a convex, hemispherical lens 1 configured to be placed over a light source 2 of a light emitting device.

As illustrated in FIG. 1A, in some embodiments, a light emitting device can comprise only one light source 2. In some embodiments, a convex, hemispherical lens 1 can be configured to be placed over the single light source 2. By placing a convex, hemispherical lens 1 over the light source 2, the distribution of light generated by the light source 2 can be controlled to a certain degree. For example, some of the generated light can be guided to exit the hemispherical cover 1 in directions that are substantially perpendicular to tangential lines at each point along the hemispherical curvature.

However, such convex, hemispherical covers 1 can be costly and inefficient. For example, some light generated by the single light source 2 or a portion thereof can be trapped in the interior space underneath the cover 1, thereby wasting at least some of the lighting capacity of the light source 2. Further, light that is trapped inside the cover 1 can further lead to heating of the interior space. The heat and/or light trapped under the cover can also add stress to the lens 1.

Furthermore, such disadvantages of convex, hemispherical covers 1 are generally multiplied for lighting devices that comprise a plurality of light sources 2. As illustrated in FIG. 1B, in order to accommodate a plurality of light sources 2, the height of a hemispherical cover 1 generally must be increased. Accordingly, there can be additional space underneath the cover 1 compared to lighting devices with only one light source 2. Due to the additional space, a larger amount of generated light can be trapped and absorbed underneath the cover 1, thereby resulting in even lower efficiency and lifetime compared to lighting devices with only one light source 2. As a result, even more heat can be generated, thereby adding to the stress exerted on the cover 1. Further, use of a hemispherical cover 1 in conjunction with a lighting device comprising a plurality of light sources 2 can also result in bulky packaging and can require highly transparent materials. For at least these reasons, it can be difficult, both economically and technically, to scale up a convex, hemispherical cover 1 for a light emitting device.

In contrast, certain embodiments of the photon enhancement guiding structures, devices, and methods for light emitting devices as described herein can provide light emitting devices with improved efficiency and/or light distribution compared to light emitting devices comprising hemispherical covers 1 while also providing a slimmer configuration or profile. As such, in certain embodiments, a light emitting device can comprise a plurality of light sources 2 while mitigating at least some of the problems discussed above related to hemispherical covers 1, including but not limited to generated light being trapped underneath the cover 1, excessive heating and/or stress on the cover 1, and distribution of light.

### LED Chips and Phosphors

Generally, LEDs can emit a variety of colors of light, some of which can be combined to produce white light. One method of producing white LED (WLED) light is to use phosphor materials that absorb blue LED-emanated light and emit yellow or greenish yellow light. As such, one or more LED chips and one or more phosphor materials can be used in combination to produce white light for lighting, backlighting displays, and/or any other lighting purpose.

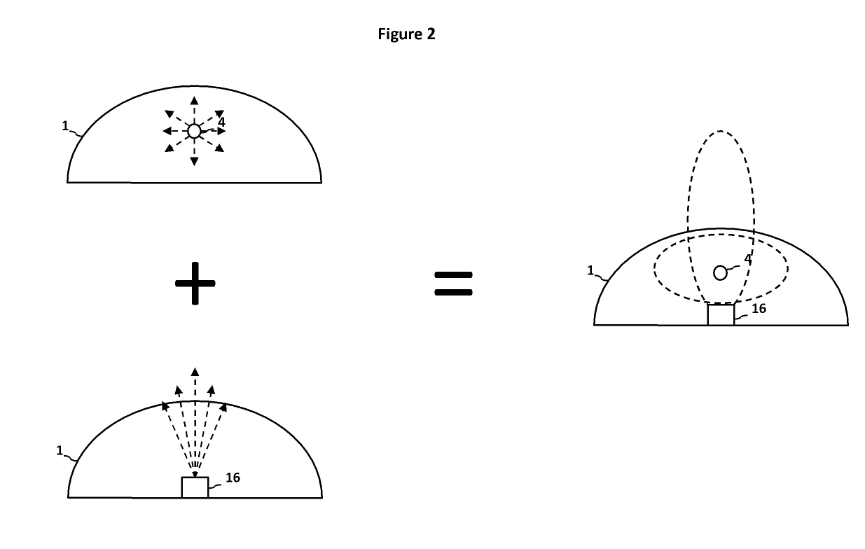

As illustrated in FIG. 2, an LED chip 16 generally emits light in a directional manner. In other words, light or colored light emitted by an LED generally travels in a substantially straight line from the LED chip 16. In contrast, a phosphor 4 generally emits light in an isotropic manner. In other words, light of colored light emitted by a phosphor 4 generally travels in all directions from the phosphor 4.

Accordingly, when light emitted from an LED chip 16 and a phosphor 4 are combined, an uneven distribution of light and/or colors is obtained as illustrated in FIG. 2. The light near the center of the LED chip 16 is denser as light emitted from both the LED chip 16 and phosphor 4 combines in that area. However, light near the sides or peripheral region of the LED chip 16 are not as dense, because only light emitted from the phosphor 4 reach the sides or peripheral region and not light emitted from the LED chip 16.

In other words, near the center of the LED chip 16, there is relatively more light emitted from the LED chip 16 than light emitted from the phosphor 4. Near the sides or peripheral regions of the LED chip 16, there can be relatively more light emitted from the phosphor 4 than light emitted from the LED chip 16. As such, a ratio of light emitted from the LED chip 16 to light emitted from the phosphor 4 is higher in the central region and lower in the sides or peripheral region. As a result, the color of light at different points can be different due to the different combinations of light emitted from the LED chip 16 and one or more phosphors 4.

In order to more evenly distribute light and/or color thereof, in some embodiments, a light emitting device can comprise photon enhancement guiding structures, devices, and methods configured to decentralize light and obtain a more even distribution of light. In certain embodiments, a portion of light near the center of the LED chip 16 can be reflected or otherwise manipulated to travel to the side or peripheral regions in order to obtain a more decentralized emission of light.

### Light Emitting Device Overview

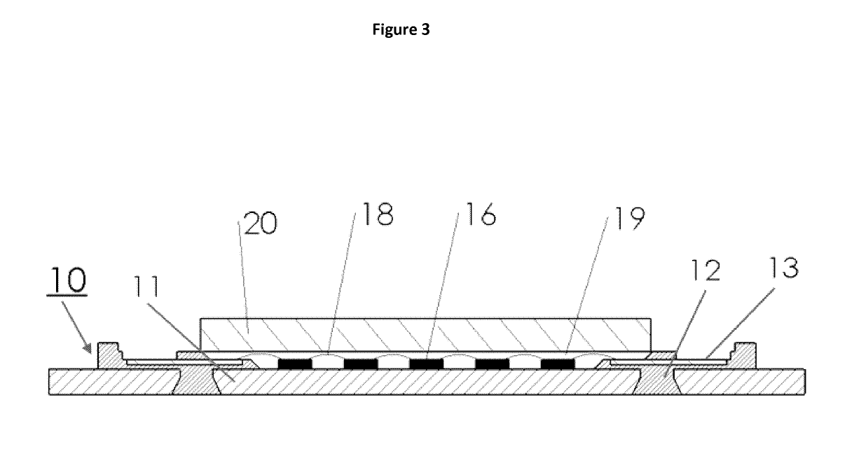

As discussed above, in some embodiments, a light emitting device can comprise one or more light sources and/or light or photon guiding structures. FIG. 3 illustrates a cross-section view of an example of an embodiment of a light emitting device comprising an embodiment of a photon enhancement guiding structure. As illustrated in FIG. 3, a light emitting device can comprise a lead-frame or chip-on-board housing 10, at least one light generating chips 16, gold wires 18 for electrical connection, encapsulation layer 19, a photon enhancement guiding structure 20, a substrate 11, electric terminal 13, and/or PPA or any supporting structure 12.

In some embodiments, a light emitting device can comprise one or more light sources or light generating chips 16. For example, the one or more light sources can comprise one or more LED light sources or any other light generating sources or chips 16. The one or more LED chips 16 can be configured to emit light beams of a first color. In some embodiments, the one or more light emitting sources or LED chips 16 can be arranged in a line and/or two-dimensional array. The two-dimensional array of light emitting chips or LED chips 16 can comprise any row and/or column dimensions.

In certain embodiments, the light emitting device and/or LED light source can further comprise an LED encapsulation layer 19. In some embodiments, the encapsulation layer 19 can made of transparent materials such as, but not limited to, silicone, glass, acrylic materials. In certain embodiments, the encapsulation layer 19 can contain one or more wavelength conversion materials such as green, yellow, orange, and/or red phosphor material 4. In other words, the LED encapsulation layer 19 can comprise at least one phosphor material 4 configured to absorb light beams of the first color from the LED 16 and emit light beams of a second color. For example, in certain embodiments, blue light emanated from LED chips 16 can be partially absorbed by phosphor materials 4 followed by emission of orange, red, and/or greenish-yellow light by one or more phosphor materials 4.

As used herein, green, yellow, orange, and/or red phosphors or phosphor materials 4 refer to wavelength conversion materials that are configured to emit light comprising wavelengths that are perceived as green, yellow, orange, and/or red respectively by normal eyes upon being activated by an appropriate wavelength.

In certain embodiments, a light or photon enhancement guiding structure 20 can be configured to be placed over the LED encapsulation 19. In certain embodiments, the photon enhancement guiding structure 20 can be made of transparent materials such as, but not limited to, silicone, PMMA, polycarbonate, and/or glass. In addition, in some embodiments, the photon enhancement guiding structure 20 can be made of material comprising certain surface texture and/or roughness in order to facilitate distribution of light. Moreover, in some embodiments, the light or photon enhancement guiding structure 20 can contain wavelength conversion materials such as green, yellow, orange, and/or red phosphor materials 4 to improve light output and/or to adjust color quality. In certain embodiments, the light or photon enhancement guiding structure 20 can be made of material with a reflective index that is equal or lower than that of the encapsulation layer 19.

The light or photon enhancement guiding structure 20 can comprise a body defined by a bottom, a top, and a side. For example, one or more top surfaces, side surfaces, and/or bottom surfaces of the photon enhancement guiding structure 20 or portions thereof can be made of transparent materials. In some embodiments, the light guiding structure body can be configured receive light beams from the LED encapsulation 19 from the bottom and direct such light to the top. In certain embodiments, the top of the light guiding structure 20 or a portion thereof comprises a total reflection surface configured to totally reflect at least part of incident light beams within the light guiding structure 20 and redirect the totally reflected light beams toward the side. As a result, in certain embodiments, emitted light is not only emitted from the top surface of the optical structure but also from the side surfaces, resulting in more side light emission.

### Photon Enhancement Guiding Structure—Structural Overview

As described above, in some embodiments, a light emitting device comprises a light or photon enhancement guiding structure 20. The light or photon enhancement guiding structure 20 can be configured to enhance light distribution of a light emitting device.

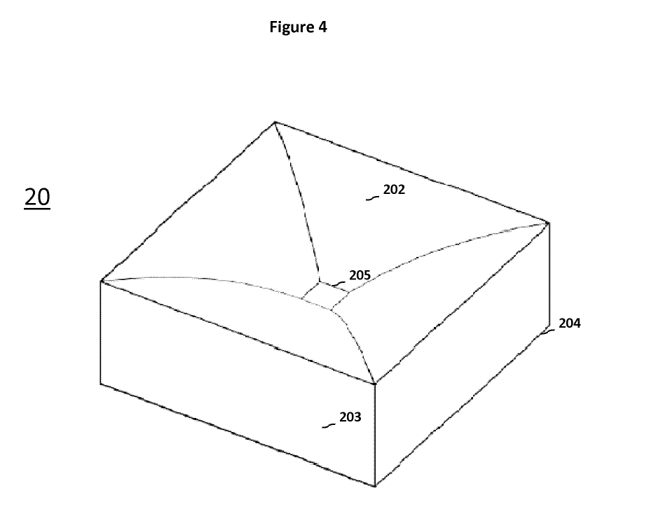

FIG. 4 illustrates a perspective view of an example of an embodiment of a photon enhancement guiding structure 20. As illustrated, some embodiments of a photon enhancement guiding structure 20 comprise one or more top, bottom, and/or side portions. The top, bottom, and/or side portions can further comprise one or more surfaces in certain embodiments. In some embodiments, the one or more top and/or side portions or surfaces thereof can be segmented unlike those of a hemispherical cover that comprises a single, continuous top and side portion.

In some embodiments, the light emitting device comprises a light or photon enhancement guiding structure 20 can be configured to be placed over a light source and/or LED encapsulation 19. Light emitted from the light source and/or LED encapsulation 19 can be configured to travel through the bottom portion of the photon enhancement guiding structure 20 and through the top and/or side portions thereof.

### Photon Enhancement Guiding Structure—Top Portion

In some embodiments, a top portion of a photon enhancement guiding structure 20 comprises one or more top surfaces 202, 205. The one or more top surfaces 202, 205 can be parallel, angled, and/or curved with respect to an imaginary plane generally parallel to the bottom of the photon enhancement guiding structure 20. For example, in some embodiments, the one or more top surfaces 202, 205 can be angled such that a point along a top surface 202, 205 that is further from the center of the photon enhancement guiding structure 20 is at a higher level than a point along the same top surface 202, 205 that is closer to the center of the photon enhancement guiding structure 20. In certain embodiments, the one or more top surfaces 202, 205 can comprise a concave and/or convex surface when viewing from outside the photon enhance guiding structure 20.

In some embodiments, the one or more top surfaces 202, 205 can be segmented from each other. In certain embodiments, one of the plurality of top surfaces 202, 205 can form one or more angles with one or more other top surfaces 202, 205. For example, an angle formed between a top surface 202, 205 and one or more other top surfaces 202, 205 at any given point can be about 10°, about 20°, about 30°, about 40°, about 50°, about 60°, about 70°, about 80°, about 90°, about 100°, about 110°, about 120°, about 130°, about 140°, about 150°, about 160°, about 170°, or can vary within a range defined by two or more of the aforementioned angles. In other embodiments, a top surface 202, 205 is not segmented from one or more other top surfaces. Rather, a top surface 202, 205 can form a continuous surface with one or more other top surfaces 202, 205.

In certain embodiments, one or more top surfaces 202, 205 are segmented from one or more side surfaces 203. The one or more top surfaces 202, 205 can form an angle with the one or more side surfaces 203. For example, the angle formed between the one or more top surfaces 202, 205 and the one or more side surfaces 203 at any given point can be about 10°, about 20°, about 30°, about 40°, about 50°, about 60°, about 70°, about 80°, about 90°, about 100°, about 110°, about 120°, about 130°, about 140°, about 150°, about 160°, about 170°, or can vary within a range defined by two or more of the aforementioned angles. In some embodiments, the angle between one or more top surfaces 202, 205 and the one or more side surfaces 203 ranges from about 0° to about 90°. The one or more top 202, 205 and/or side surfaces 203 can be straight, curved, and/or angled. In other embodiments, one or more top surfaces 202, 205 are not segmented from one or more side surfaces 203. Rather, the one or more top surfaces 202, 205 can form a continuous surface with one or more side surfaces 203.

In some embodiments, one or more top surfaces 202, 205 or portions thereof can comprise an angle with respect to an imaginary plane parallel to the bottom surface 204. For example, the angle between the one or more top surfaces 202, 205 or portions thereof and the imaginary plane parallel to the bottom surface 204 at any given point can be about 0°, about 10°, about 20°, about 30°, about 40°, about 50°, about 55°, about 60°, about 70°, about 80°, about 90°, about 100°, about 110°, about 120°, about 130°, about 140°, about 150°, about 160°, about 170°, about 180°, or within a range defined by two or more of the aforementioned angles. In some embodiments, the angle between one or more top surfaces 202, 205 and the imaginary plane parallel to the one or more bottom surfaces 204 ranges from about 0° to about 55°.

As illustrated in FIG. 4, some embodiments of a photon enhancement guiding structure 20 comprise one or more flat top surfaces 205. The one or more flat top surfaces 205 can be substantially parallel to a bottom surface 204 of the photon enhancement guiding structure 20. However, in certain embodiments, the photon enhancement guiding structure 20 does not comprise any flat top surfaces 205 that are substantially parallel to the bottom surface 204.

### Photon Enhancement Guiding Structure—Side Portion

In some embodiments, a side portion of a photon enhancement guiding structure 20 comprises one or more side surfaces 203. The one or more side surfaces 203 can be segmented from each other. In certain embodiments, one of the plurality of side surfaces 203 can form one or more angles with one or more other side surfaces 203. For example, an angle formed between a side surface 203 and one or more other side surfaces 203 at any given point can be about 10°, about 20°, about 30°, about 40°, about 50°, about 60°, about 70°, about 80°, about 90°, about 100°, about 110°, about 120°, about 130°, about 140°, about 150°, about 160°, about 170°, or can vary within a range defined by two or more of the aforementioned angles. In other embodiments, a side surface 203 is not segmented from one or more other side surfaces 203. Rather, a side surface 203 can form a continuous surface with one or more other side surfaces 203.

In certain embodiments, one or more side surfaces 203 are segmented from one or more bottom surfaces 204. The one or more side surfaces 203 can form an angle with the one or more bottom surfaces 204. For example, the angle formed between the one or more side surfaces 203 and the one or more bottom surfaces 204 at any given point can be about 10°, about 20°, about 30°, about 40°, about 50°, about 60°, about 70°, about 80°, about 90°, about 100°, about 110°, about 120°, about 130°, about 140°, about 150°, about 160°, about 170°, or can vary within a range defined by two or more of the aforementioned angles. In some embodiments, the angle between one or more side surfaces 203 and the one or more bottom surfaces 204 ranges from about 45° to about 135°. The one or more side 203 and/or bottom surfaces 204 can be straight, curved, and/or angled. In other embodiments, one or more side surfaces 203 are not segmented from one or more bottom surfaces 204. Rather, the one or more side surfaces 203 can form a continuous surface with one or more bottom surfaces 204.

### Light Pattern—Top Surface

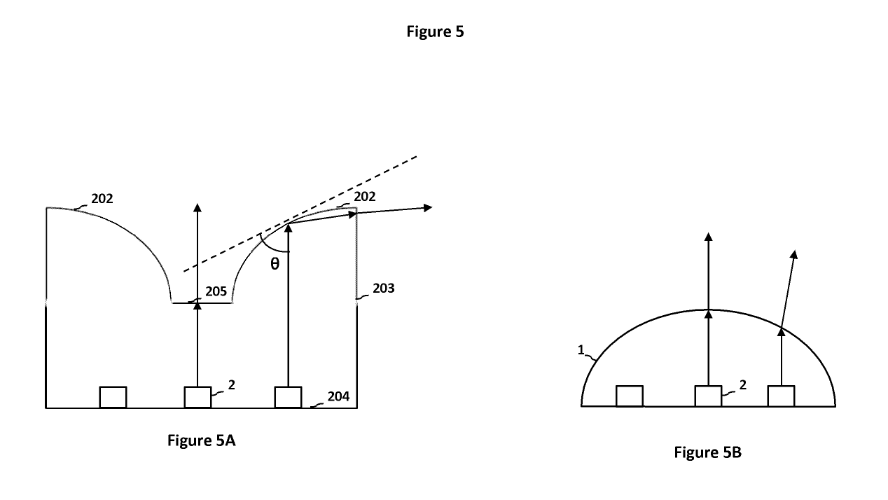

In some embodiments, by placing a light or photon enhancement guiding structure 20 over a light source and/or LED encapsulation 19, light that is emitted from the light source and/or LED encapsulation 19 can be configured to reflect and/or refract at particular angles as the light travels through and/or out of the light or photon enhancement guiding structure 20. FIGS. 5A and 5B illustrate light travel patterns in examples of embodiments of photon enhancement guiding structures 20 with different top portions.

More specifically, FIG. 5A illustrates a cross-section view of light travel patterns in an example of an embodiment of a photon enhancement guiding structure 20 with one or more top surfaces 202, 205. As illustrated in FIG. 5A, in certain embodiments, a top portion comprises a plurality of top surfaces 202, 205 that are flat, curved, and/or angled with respect to an imaginary plane that is parallel to the bottom portion or surface 204 of the photon enhancement guiding structure 20.

As illustrated, in some embodiments, a light emitting device can comprise a plurality of light sources 2 covered by a photon enhancement guiding structure 20. For example, a light source 2 can be located substantially underneath the center of the photon enhancement guiding structure 20. Further, one or more light emitting sources 2 can be located substantially underneath the peripheral regions of the photon enhancement guiding structure 20.

In some embodiments, one or more top surfaces 202, 205 can be made of transparent material such that light can be emitted and/or transmitted through the one or more top surfaces 202, 205. For example, in certain embodiments, substantially all light emitted from one or more light sources 2 located substantially underneath the center of the photon enhancement guiding structure 20 can be transmitted through and out of a top surface 205 in a vertical direction that is substantially perpendicular to the bottom surface 204 of the photon enhancement guiding structure 20.

In certain embodiments, light emitted from one or more light sources 2 can be refracted by an angle at the top surface 202, 205. The angle of refraction can depend on the refractive index of the material of that particular top surface 202, 205 and/or the angle between the initial path of light before contacting the top surface 202, 205 and a line tangential to the point of contact along the top surface 202, 205. For example, the angle of refraction of a path of light can be about 0°, about 10°, about 20°, about 30°, about 40°, about 50°, about 60°, about 70°, about 80°, about 90°, about 100°, about 110°, about 120°, about 130°, about 140°, about 150°, about 160°, about 170°, about 180°, or within a range defined by two or more of the aforementioned angles.

In certain embodiments, one or more top surfaces 202, 205 can comprise a total reflection surface. For example, the total reflection surface can be configured to totally reflect substantially all incident light beams that are incident thereto within the photon enhancement guiding structure 20 at an angle θ smaller than a particular angle, wherein the angle is defined between the initial path of light underneath the top surface of the photon enhancement guiding structure 20 and a line tangential to a point on the flat, curved, and/or angular top surface 202, 205 on an imaginary plane including the initial path of light. In other words, the initial light path underneath the top surface 202, 205 can be totally reflected when it contacts a totally reflective top surface 202, 205 at a certain angle and not travel through that particular top surface 202, 205. For example, in certain embodiments, light emitted from one or more light sources 2 located underneath a peripheral region of the photon enhancement guiding structure 20 can be totally reflected when it contacts the top surface 202.

In some embodiments, depending on the material of the top surface 202, 205, the maximum angle between the initial path of light underneath the top surface 202, 205 of the photon enhancement guiding structure 20 and a line tangential to a point on the flat, curved, and/or angular top surface 202, 205 that allows for total reflection can be about 5°, about 10°, about 15°, about 20°, about 25°, about 30°, about 35°, about 40°, about 45°, about 50°, about 55°, about 60°, about 65°, about 70°, about 75°, about 80°, about 85°, or within a range defined by two or more of the aforementioned angles.

In certain embodiments, a top portion of a photon enhancement guiding structures comprises one or more total reflection surfaces and/or one or more non-total reflection surfaces. For example, in the embodiment illustrated in FIG. 5A, the top portion of a photon enhancement guiding structure comprises at least two total reflection surfaces 202 as viewed from a cross-section taken in a plane generally perpendicular to the bottom surface. The at least two total reflection surfaces 202 can be configured to redirect light beams to generally opposite directions. In certain embodiments, the at least two total reflection surfaces 202 can be mirror images of each other along an imaginary line that is generally perpendicular to the bottom surface 204.

In some embodiments, the at least two total reflection surfaces 202 meet at about the imaginary line on the cross-section. In other embodiments, the at least two total reflection surfaces 202 are connected by an additional surface 205 located in between the at least two total reflection surfaces. The additional surface 205 can be total reflection surface or a non-total reflection surface. For example, in certain embodiments, the at least two total reflection surfaces 202 are connected by a non-total reflection surface that is configured to transmit substantially all incident light beams thereto within the photon enhancement guiding structure 20 rather than reflecting the incident light beams within the photon enhancement guiding structure. In other embodiments, the at least two total reflection surfaces 202 are connected by one or more additional total reflection surfaces that are configured to totally reflect at least part of the incident light beams thereto within the photon enhancement guiding structure 20 and redirect the totally reflected light beams to another portion and/or surface of the top portion.

In some embodiments, the totally reflected light can then be transmitted and/or refracted at one or more side surfaces 203. Accordingly, by controlling the reflection and/or refraction at the top surface 202, 205 of the photon enhancement guiding structure 20, a light path and/or distribution at the one or more side surfaces 203 can be varied and/or controlled. For example, in certain embodiments, the angle and/or curvature of one or more top surfaces 202, 205 can be configured in order to increase the amount of light that is emitted to one or more side surfaces 203 in a substantially horizontal and/or angled direction.

In some embodiments, because of the refraction and/or reflection, the combination of light emitted from one or more light emitting chips or LED chips 16 and light emitted from one or more phosphors 4 can be varied from that of a hemispherical lens 1 or other cover. Accordingly, in certain embodiments, the combination of light emitted from one or more light emitting chips or LED chips 16 and light emitted from one or more phosphors 4 can be pre-configured and/or pre-designed by altering the angle and/or curvature of one or more top surfaces 202, 205. Alterations in the angle and/or curvature of one or more top surfaces 202, 205 can effectively alter the angle of reflection and/or refraction of light within the photon enhancement guiding structure 20 and/or as it passes through the photon enhancement guiding structure 20. As a result, the combination of light emitted from one or more light emitting chips or LED chips 16 and light emitted from one or more phosphors 4, or color distribution, can be controlled.

In contrast, for light emitting devices comprising a hemispherical lens 1, options for controlling and/or varying the reflection and/or refraction of light are limited or lacking. FIG. 5B is a cross-section view of an example of a hemispherical lens. As illustrated in FIG. 5B, hemispherical covers 1 generally comprise a single curvature throughout the top and/or side of the hemispherical lens 1. As a result, it can be difficult if not impossible to control and/or vary the light distribution nature and/or color distribution, because there is only one surface throughout the top portion. In other words, the amount of light that is emitted in a horizontal direction from the light emitting device or color composition thereof can be limited or difficult to control.

### Light Pattern—Side Surface

Similar to the top portion, the side portion of a photon enhancement guiding structure 20 and/or one or more side surfaces thereof can be configured to refract and/or transmit light. Light that is refracted and/or transmitted through the one or more side surfaces 203 can be directly emitted from one or more light sources 2 or can be reflected and/or refracted from one or more top 202, 205 and/or bottom surfaces 204.

In some embodiments, one or more side surfaces 203 can be made of transparent material. By introducing transparent side surfaces 203, the light extraction area and light extraction can be increased. Further, transparent side surfaces can allow for more light to be guided and emitted from the side surfaces 203 in a substantially horizontal direction or in a direction closer to the horizontal direction that the vertical direction, wherein the horizontal direction is substantially parallel to the bottom surface 204 of the photon enhancement guiding structure 20.

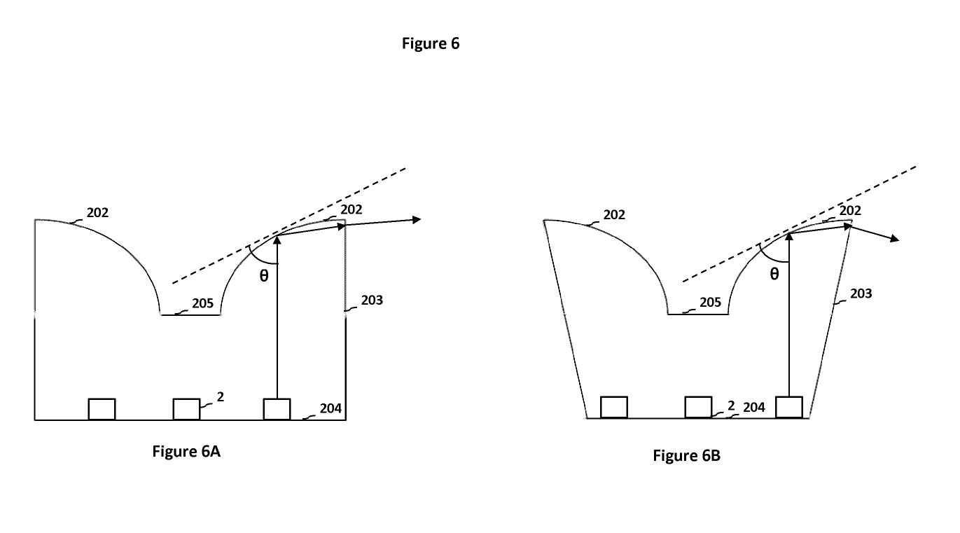

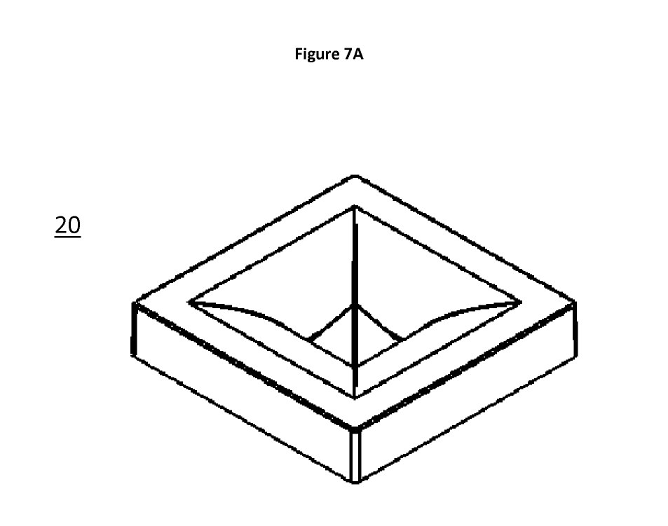

FIGS. 6A-6B illustrate cross-section views of light travel patterns in examples of embodiments of photon enhancement guiding structures 20 with varying side surfaces 203. In some embodiments, the side portion does not comprise any total reflection surfaces such that substantially all light beams incident to the side within the photon enhancement guiding structure 20 are transmitted through the side to the exterior of the photon enhancement guiding structure 20. In certain embodiments, the side portion comprises one or more side surfaces 203 configured to transmit and/or refract light beams incident to the side.

As shown in FIG. 6A, in some embodiments, one or more side surfaces 203 are substantially vertical and perpendicular to the bottom portion. Accordingly, light emitted from a light source 2 located under a peripheral region of the photon enhancement structure 20 that has been reflected and/or totally reflected at one or more top surfaces 202, 205 can be minimally refracted and transmitted through one or more side surfaces 203.

As shown in FIG. 6B, in some embodiments, one or more side surfaces are angled and/or curved with respect to the bottom portion 204. Accordingly, light emitted from a light source 2 located under a peripheral region of the photon enhancement structure 20 that has been refracted and/or totally reflected at one or more top surfaces 202, 205 can be refracted and/or transmitted through one or more side surfaces 203. As such, by varying the angle and/or curvature of one or more side surfaces 203, the refractive degree of a path of light and distribution thereof outside the photon enhancement guiding structure 20 and be varied.

The angle of refraction can depend on the refractive index of the material of that particular side surface 203 and/or the angle between the initial path of light before contacting the side surface 203 and a line tangential to the point of contact along the side surface 203. For example, the angle of refraction of the path of light can be about 0°, about 10°, about 20°, about 30°, about 40°, about 50°, about 60°, about 70°, about 80°, about 90°, about 100°, about 110°, about 120°, about 130°, about 140°, about 150°, about 160°, about 170°, about 180°, or within a range defined by two or more of the aforementioned angles.

### Photon Enhancement Guiding Structure—Cone or Pyramid Portion

In some embodiments, the top portion of a photon enhancement guiding structure 20 can comprise at least one cone and/or pyramid portion 201. One or more other top surfaces 202 can be connected to the cone and/or pyramid portion 201. The cone and/or pyramid portion 201 can be configured to facilitate light extraction near or substantially underneath the cone and/or pyramid portion 201 and redistribute the light towards other portions and/or top surfaces 202. For example, in certain embodiments, the cone and/or pyramid portion 201 can be located near the center of the top portion.

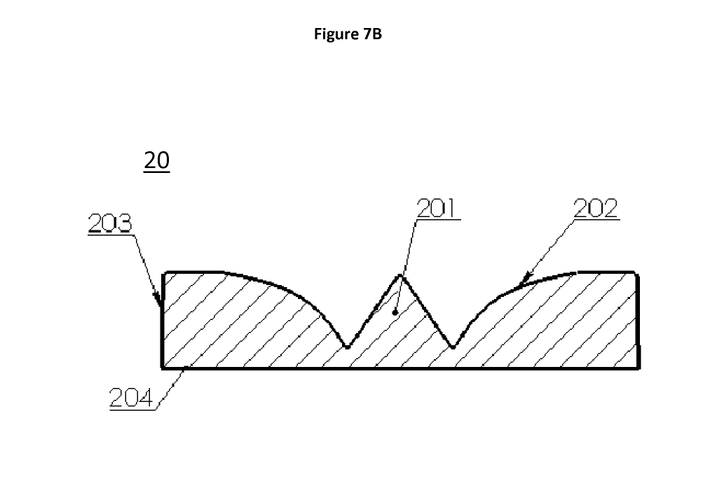

FIGS. 7A-7B illustrate a perspective view and a cross-section view respectively of an example of an embodiment of a photon enhancement guiding structure 20 comprising a cone and/or pyramid portion 201 located near the center of the top portion. In the shown embodiment, the center cone or pyramid 201 can be configured such that a significant amount of light reflects at a first incident at one side of the cone or pyramid 201 and then refracts at the opposite side of the cone or pyramid 201 at a second incident. This light, which can be denoted as a “reflective refractive light” can be configured to be bent toward a larger viewing angle direction from the first and second incidents.

In other embodiments, the top portion of a photon enhancement guiding structure 20 can comprise a plurality of cone and/or pyramid portions 201. For example, the top portion can be configured to provide a cone and/or pyramid portion 201 substantially above all or a number of light sources 2 or LED chips 16.

### Photon Enhancement Guiding Structure—No Flat or Cone or Pyramid Portion

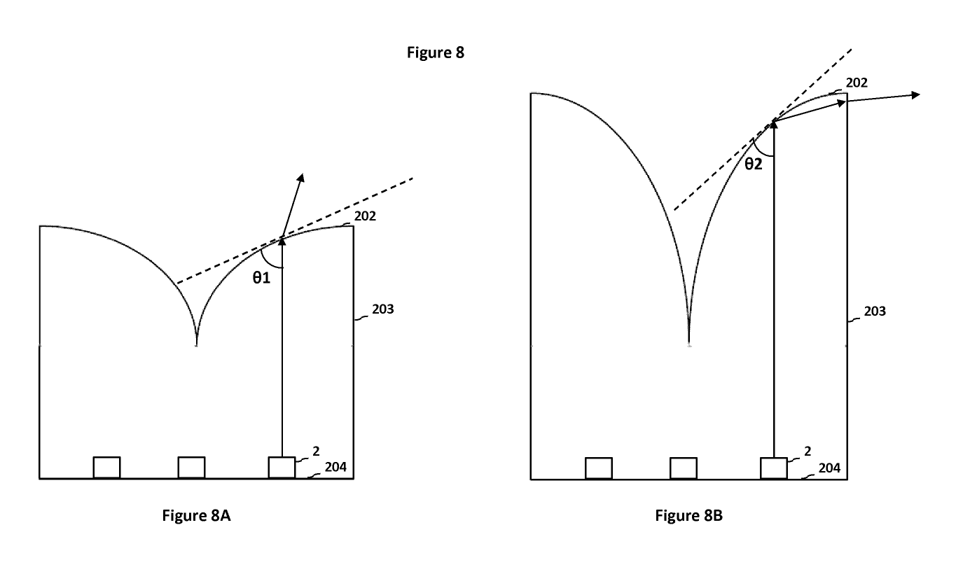

In some embodiments, the top portion of a photon enhancement guiding structure 20 does not comprise a cone or pyramid portion 201 or a flat portion 205 that is substantially parallel to the bottom portion 204. Rather, in some embodiments, the top portion of a photon enhancement guiding structure 20 comprises only total reflection surfaces 202 that are curved and/or angled with respect to an imaginary plane that is parallel to the bottom surface 204. FIGS. 8A and 8B illustrate light travel patterns of examples of embodiments of photon guiding structures 20 comprising a top portion without a cone or pyramid structure 201 or a flat portion 205.

As illustrated in FIGS. 8A-8B, however, such photon guiding structures 20 generally must be thicker in order to obtain total reflection near the peripheral regions in such embodiments. For example, the embodiment illustrated in FIG. 8A is thinner in vertical depth as measured from the bottom surface 204 to the top portion compared to the embodiment illustrated in FIG. 8B. In both embodiments illustrated in FIGS. 8A and 8B, a light source 2 is located underneath a peripheral region of the photon enhancement guiding structure 20. In the embodiment illustrated in FIG. 8A, light emitted from this light source 2 is refracted and transmitted through the top surface 202, whereas in the embodiment illustrated in FIG. 8B, light emitted from this light source 2 is totally reflected and transmitted through a side surface 203.

More specifically, in the embodiment illustrated in FIG. 8A, the initial light path before contacting the top surface 202 forms an angle, θ1, with a line that is tangential to the point of contact between the light path and the top surface 202. Despite the fact that top surface 202 located above the particular light source 2 comprises a total reflection surface, because the angle θ1 is larger than a threshold angle for total reflection, the light is not totally reflected but is rather refracted and transmitted through the top surface 202 in some embodiments.

In contrast, in the embodiment illustrated in FIG. 8B, the photon enhancement guiding structure 20 overall is substantially thicker than that illustrated in FIG. 8A. Accordingly, the curvature of the top surface 202 located above the same light source 2 is greater. As a result, the angle θ2 formed between the initial light path before contacting the top surface 202 and a line that is tangential to the point of contact between the light path and the top surface 202 is smaller than angle θ1 and a threshold angle for total reflection. Accordingly, light is totally reflected and transmitted through the side surface 203 in some embodiments as illustrated in FIG. 8B.

As illustrated in FIGS. 8A-8B, in order to obtain total reflection and redirect light emitted near the peripheral regions to one or more side surfaces 203, the photon enhancement guiding structure 20 needs to be thicker than that necessary for redirecting only those light beams near the center. Accordingly, in order to effectively redirect even those light beams that are emitted near the peripheral regions, such photon enhancement guiding structures 20 need to be rather bulky.

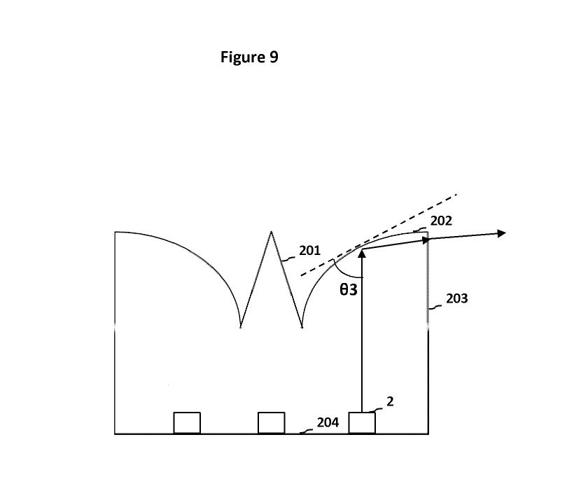

However, by employing a flat portion 205, cone and/or pyramid structure 201 near the center of the top portion, a photon enhancement guiding structure 20 does not need to be as thick while effectively redirecting light emitted in the peripheral regions to one or more side surfaces 205. FIG. 9 illustrates light travel patterns in an example of an embodiment of a photon enhancement guiding structure 20 comprising a top portion with a cone and/or pyramid structure 201.

As illustrated in FIG. 9, because of the cone or pyramid portion 201 near the center of the top portion, the curvature of a total reflection surface does not begin at the very center of the photon enhancement guiding structure 20 in some embodiments. Rather, the curvature can begin off of the center of the photon enhancement guiding structure 20. As a result, the curvature of the photon enhancement guiding structure 20 near the peripheral region can be greater than the embodiment illustrated in FIG. 8A without making the photon enhancement guiding structure 20 thicker.

Because of the greater curvature, in some embodiments, the angle θ3 formed between the initial light path before contacting the top surface 202 and a line that is tangential to the point of contact between the light path and the top surface 202 is smaller than angle θ1 and a threshold angle for total reflection. Accordingly, light can be totally reflected and transmitted through the side surface 203 in the embodiment illustrated in FIG. 9. By guiding more light towards and through the side surface 203, greater and more even light distribution can be obtained. At the same time, the thickness of the photon enhancement guiding structure 20 can be substantially thinner in some embodiments as illustrated in FIG. 9 than in other embodiments as illustrated in FIG. 8B.

### Photon Enhancement Guiding Structure—Additional Reflective Surface

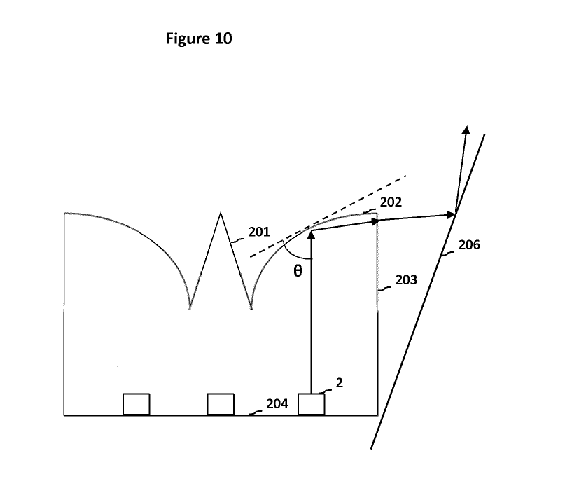

In some embodiments, one or more additional reflective surfaces 206 can be used in conjunction with a photon enhancement guidance structure 20 in order to further reflect and/or transmit light as needed. FIG. 10 illustrates light emitting patterns in an example of an embodiment of an additional reflective surface 206 used in conjunction with a photon enhancement guiding structure 20.

As illustrated in FIG. 10, one or more additional reflective surfaces 206 can be placed near a photon enhancement guiding structure 20. In some embodiments, light emitted, redirected, and/or transmitted through one or more top 201, 202 and/or side surfaces 203 of the photon enhancement guiding structure 20 is further reflected at the one or more additional reflective surfaces 206. The one or more additional reflective surfaces 206 can be located and/or positioned in a plurality of configurations in order to redirect light in a particular direction as needed.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the inventions or claims.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Additionally, the skilled artisan will recognize that any of the above-described methods can be carried out using any appropriate apparatus. Further, the disclosure herein of any particular feature, aspect, method, property, characteristic, quality, attribute, element, or the like in connection with an embodiment can be used in all other embodiments set forth herein. For all of the embodiments described herein the steps of the methods need not be performed sequentially. Thus, it is intended that the scope of the present invention herein disclosed should not be limited by the particular disclosed embodiments described above.

What is claimed is:

1. A light emitting device:
an LED light source comprising a light emitting diode (LED) and an encapsulation encapsulating the LED, the LED being configured to emit light beams of a first color, the encapsulation comprising at least one phosphor material configured to absorb light beams of the first color from the LED and emit light beams of a second color;
a light guide structure placed over the LED encapsulation, the light guide structure comprising a body defined by a bottom, a top and a side, the light guide structure body being configured to receive via the bottom and direct to the top light beams from the LED encapsulation; and
the top comprising a total reflection surface configured to totally reflect at least part of incident light beams thereto within the light guide structure body and redirect the totally reflected light beams toward the side.

2. The device of claim 1, wherein the total reflection surface is configured to totally reflect substantially all incident light beams that are incident thereto within the light guide structure body at an angle smaller than about 75°, wherein the angle is defined as one between a trajectory of the incident light beam to a point on the total reflection surface and a tangential line at the point on an imaginary plane including the trajectory of the incident light beam.

3. The device of claim 1, wherein the side does not comprise a total reflection surface such that substantially all light beams incident to the side within the light guide structure body are transmitted through the side to outside the light guide structure body.

4. The device of claim 1, wherein the total reflection surface is slanted or curved with reference to an imaginary plane generally parallel to the bottom of the light guide structure.

5. The device of claim 4, wherein between two points on the total reflection surface, one that is closer to the side is at a level higher than one that is farther to the side, wherein the level is measured with reference to the bottom.

6. The device of claim 4, wherein a tangential line at a point of the total reflection surface and the imaginary plane form an acute angle ranging from about 20° to about 70°.

7. The device of claim 1, wherein the top further comprise another total reflection surface on a cross-section of the light guide structure body taken in a plane generally perpendicular to the bottom.

8. The device of claim 7, wherein the two total reflection surfaces on the cross-section are configured to redirect light beams to generally opposite directions.

9. The device of claim 7, wherein the cross-section is divided into two areas by an imaginary line perpendicular to the bottom, wherein one the two total reflection surfaces is located in one side and the other of the two total reflection surfaces is located in the other side.

10. The device of claim 9, wherein the two total reflection surfaces meet at about the imaginary line on the cross-section.

11. The device of claim 9, wherein the two total reflection surfaces are generally in a mirror image of each other along the imaginary line.

12. The device of claim 9, wherein the top further comprises a non-total reflection surface between the two total reflection surfaces on the cross-section, wherein the non-total reflection surface is configured to transmit substantially all incident light beams thereto within the light guide structure body rather than reflecting the incident light beams into the light guide structure body.

13. The device of claim 9, wherein the top further comprises one or more additional total reflection surfaces between the two total reflection surfaces on the cross-section, wherein the one or more additional total reflection surfaces are configured to totally reflect at least part of incident light beams thereto within the light guide structure body and redirect the totally reflected light beams to another portion of the top.

14. The device of claim 9, wherein the top comprises at least one cone-shaped top portion between the two total reflection surfaces on the cross-section.

15. The device of claim 1, wherein the total reflection surface and the side form an edge, wherein the total reflection surface is slanted or curved such that a point on the edge is higher than another point of the total reflection surface.

16. The device of claim 1, wherein the total reflection surface comprises a convex surface when viewing from outside the light guide structure body.

17. The device of claim 1, wherein the LED light source comprises one or more additional LEDs forming an LED array.

18. A method of directing light beams, the method comprising:
providing the device of claim 1;
emitting light beams from the LED light source toward the light guide structure so that a light beam enters the light guide structure body and travels toward the total reflection surface of the top; and
reflecting the light beam at the total reflection surface and directing the light beam to the side of the light guide structure such that the light beam passes the side to outside the light guide structure body.

19. The method of claim 18, further comprising:
providing a reflective surface next to the side of the light guide structure; and
reflecting at the reflective surface the light beam that has been redirected to the side and travels to outside the light guide structure body.

20. A light emitting device:
an LED light source configured to emit light beams of a first color;
an LED encapsulation layer encapsulating the LED light source and further comprising at least one phosphor material configured to absorb light beams of the first color from the LED light source and emit light beams of a second color;
a light guide structure placed over the LED encapsulation layer, the light guide structure comprising a body defined by a bottom, a top and a side, the light guide structure body being configured to receive via the bottom and direct to the top light beams from the LED encapsulation layer; and
the top comprising a total reflection surface configured to totally reflect at least part of incident light beams thereto within the light guide structure body and redirect the totally reflected light beams toward the side.
